(19) United States
(12) Patent Application Publication
(10) Pub. No.: US 2015/0289128 A1
(43) Pub. Date: Oct. 8, 2015

(54) ENHANCED DATA ACCESS TECHNIQUE FOR USER DATA FROM A HOME SUBSCRIBER SERVER

(71) Applicant: NOKIA SOLUTIONS AND NETWORKS OY, Espoo (FI)

(72) Inventors: Peter Leis, Penzberg (DE); Ulrich Wiehe, Bad Hersfeld (DE); Jiadong Shen, Munich (DE)

(21) Appl. No.: 14/438,381

(22) PCT Filed: Oct. 26, 2012
(86) PCT No.: PCT/EP2012/071219

§ 371 Date: Apr. 24, 2015

(51) Int. Cl. H04W 8/04; H04L 29/12; H04W 60/04; H04L 29/06

(52) U.S. Cl. CPC H04W 8/04; H04L 65/1016; H04L 65/1073; H04L 61/6054; H04W 60/04

(57) ABSTRACT

There are provided measures for an enhanced data access technique for user data. Such measures exemplarily comprise detection of unfeasibility of a data access of data of a specified user at a home subscriber server using a mobile subscriber telephone number due to ambiguity of the mobile subscriber telephone number as a user identity and unavailability of an international mobile subscriber identity as a private identity of the specified user, and selection of a process for enabling the data access of data of the specified user at the home subscriber server using the mobile subscriber telephone number on the basis of a necessity of the international mobile subscriber identity as a private identity for the data access of data of the specified user.

### TECHNICAL FIELD

The present invention relates to an enhanced data access technique for user data from a home subscriber server. More specifically, the present invention exemplarily relates to measures (including methods, apparatuses and computer program products) for realizing an enhanced data access technique for user data from a home subscriber server.

### BACKGROUND

The IP Multimedia Subsystem (IMS), as specified by 3GPP, is a standardized solution for multimedia telephony over IP-based networks, wherein the IMS is capable of providing mobile and fixed multimedia services. It uses a Voice-over-IP (VoIP) implementation based on the Session Initiation Protocol (SIP), runs over the standard Internet Protocol (IP), and supports existing phone systems (both packet-switched and circuit-switched). Accordingly, the IMS merges the Internet with mobile/cellular communications in that it uses mobile/cellular technologies to provide ubiquitous access and Internet technologies to provide services. For example, the IMS is applicable for Voice-over-LTE (VoLTE) to provide voice/phone services in LTE/LTE-A networks, i.e. over LTE/LTE-A radio access.

Within the IMS, as specified by 3GPP, user profiles, i.e. user data, are stored (in the context of an IMS subscription) in the Home Subscriber Server (HSS). Different network elements in the IMS can access these user data at the HSS. For example an Interrogating and Serving Call Session Control Function (I-CSCF and S-CSCF) can access the HSS via the Cx interface, and an Application Server (AS) can access the HSS via the Sh interface.

The present specification relates to a data access of user data over the Sh interface, i.e. between the AS and the HSS.

In general use cases defined for the Sh interface, when user data need to be accessed by the AS at the HSS, an IMS Public User Identity (IMPU) or a Mobile Subscriber ISDN Number (MSISDN) is used as an access key. In a first use case, if the IMPU is used as the access key but does not uniquely identify the subject data (because the IMPU is shared by several UEs), an IMS Private User Identity (IMPI) is used in addition to the IMS Public User Identity (IMPU) as an additional access key. Similar, in a second use case, if the MSISDN is used as the access key but does not uniquely identify the subject data (because the MSISDN is shared by several UEs), an International Mobile Subscriber Identity (IMSI) is used in addition to the MSISDN as an additional access key.

FIG. 1 shows a schematic diagram illustrating an accessibility of user data using various access keys according to conventional specifications.

As evident from FIG. 1, it is assumed that the HSS comprises an IMS subscription including user data e.g. for user 1 and user 2, respectively. Further, it is assumed that IMPU1 and MSISDN represent ambiguous user identities which are shared between users 1 and 2, while IMPU2 represents a unique user identity for user 2. Accordingly, the user data for user 1 can be accessed by using IMPU1 and IMPI1 as access keys or by using MSISDN and IMSI1 as access keys, the user data for user 2 can be accessed by using IMPU1 and IMPI2 as access keys or by using MSISDN and IMSI2 as access keys or by using IMPU2 as an access key.

The first use case (i.e. using of IMPI in addition to IMPU as access keys) works fine, since the IMPI is typically available at the AS. However, the second use case (i.e. using IMSI in addition to MSISDN as access keys) is problematic, since the IMSI is generally not available at the AS.

In view thereof, there resides a problem in that the AS is not capable of successfully accomplishing a data access for retrieving user data from the HSS using a MSISDN when the MSISDN is ambiguous in terms of user (i.e. UE) identification. Therefore, assuming sharing of MSISDNs between users (i.e. UEs), the AS is not capable of accessing user data being accessible using the MSISDN, potentially in combination with the IMSI (rather than the IMPU, potentially in combination with the IMPI).

Accordingly, there is a demand for an enhanced data access technique for user data from a home subscriber server.

### SUMMARY

Various exemplary embodiments of the present invention aim at addressing at least part of the above issues and/or problems and drawbacks.

Various aspects of exemplary embodiments of the present invention are set out in the appended claims.

According to an exemplary aspect of the present invention, there is provided a method comprising detecting unfeasibility of a data access of data of a specified user at a home subscriber server using a mobile subscriber telephone number due to ambiguity of the mobile subscriber telephone number as a user identity and unavailability of an international mobile subscriber identity as a private identity of the specified user, determining a necessity of the international mobile subscriber identity of the specified user as a private identity for the data access of data of the specified user at the home subscriber server, and selecting a process for enabling the data access of data of the specified user at the home subscriber server using the mobile subscriber telephone number on the basis of the determined necessity of the international mobile subscriber identity.

According to an exemplary aspect of the present invention, there is provided a method comprising registering data of a specified user, which is accessible using a mobile subscriber telephone number being ambiguous as a user identity, and executing data access using the mobile subscriber telephone number in accordance with a selected process for enabling the data access of data of the specified user using the mobile subscriber telephone number depending on a necessity of an international mobile subscriber identity of the specified user for the data access of data of the specified user at the application server.

According to an exemplary aspect of the present invention, there is provided an apparatus comprising a connector configured to connect to at least another apparatus, a memory configured to store computer program code, and a processor configured to cause the apparatus to perform: detecting unfeasibility of a data access of data of a specified user at a home subscriber server using a mobile subscriber telephone number due to ambiguity of the mobile subscriber telephone number as a user identity and unavailability of an international mobile subscriber identity as a private identity of the specified user, determining a necessity of the international mobile subscriber identity of the specified user as a private identity for the data access of data of the specified user at the home subscriber server, and selecting a process for enabling the data access of data of the specified user at the home subscriber server using the mobile subscriber telephone number on the basis of the determined necessity of the international mobile subscriber identity.

According to an exemplary aspect of the present invention, there is provided an apparatus comprising a connector configured to connect to at least another apparatus, a memory configured to store computer program code, and a processor configured to cause the apparatus to perform: registering data of a specified user, which is accessible using a mobile subscriber telephone number being ambiguous as a user identity, and executing data access using the mobile subscriber telephone number in accordance with a selected process for enabling the data access of data of the specified user using the mobile subscriber telephone number depending on a necessity of an international mobile subscriber identity of the specified user for the data access of data of the specified user at the application server.

According to an exemplary aspect of the present invention, there is provided a computer program product comprising computer-executable computer program code which, when the program is run on a computer (e.g. a computer of an apparatus according to any one of the aforementioned apparatus-related exemplary aspects of the present invention), is configured to cause the computer to carry out the method according to any one of the aforementioned method-related exemplary aspects of the present invention.

The computer program product may comprise or may be embodied as a (tangible) computer-readable (storage) medium or the like on which the computer-executable computer program code is stored, and/or the program is directly loadable into an internal memory of the computer or a processor thereof.

Advantageous further developments or modifications of the aforementioned exemplary aspects of the present invention are set out in the following.

By way of exemplary embodiments of the present invention, there is provided an enhanced data access technique for user data from a home subscriber server, which is specifically applicable between an application server and a home subscriber server in an IP Multimedia Subsystem.

Thus, improvement is achieved by methods, apparatuses and computer program products enabling/realizing an enhanced data access technique for user data from a home subscriber server.

### BRIEF DESCRIPTION OF THE DRAWINGS

In the following, the present invention will be described in greater detail by way of non-limiting examples with reference to the accompanying drawings, in which

FIG. 1 shows a schematic diagram illustrating an accessibility of user data using various access keys according to conventional specifications,

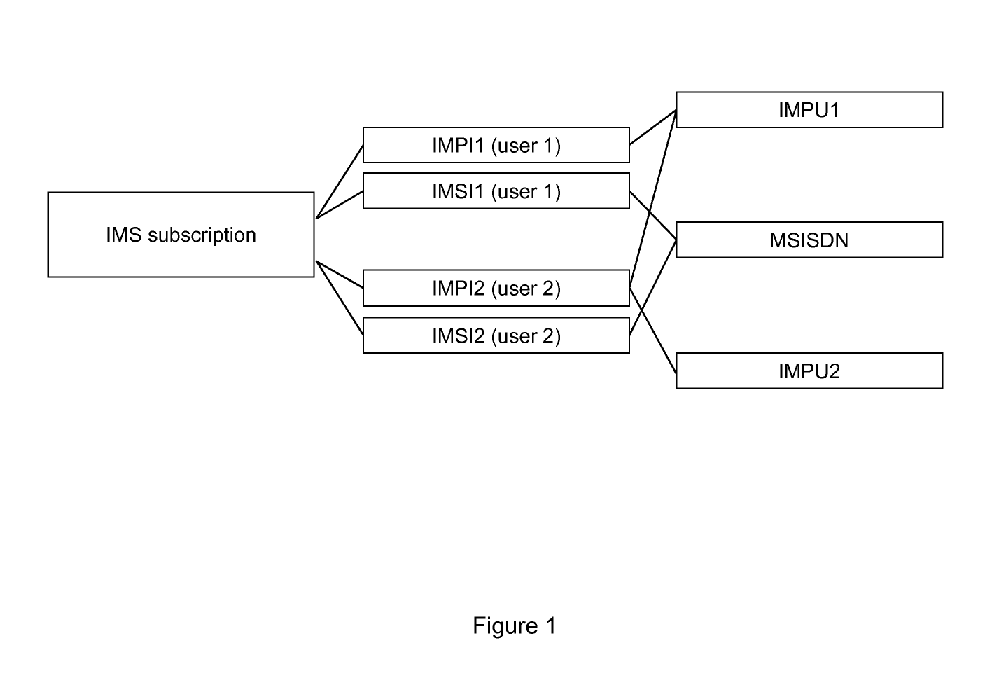

FIG. 2 shows a flowchart of a procedure operable at an application server according to exemplary embodiments of the present invention,

FIG. 3 shows a flowchart of a procedure operable at a home subscriber server according to exemplary embodiments of the present invention,

FIG. 4 shows a signaling diagram of a first example of a data access process according to exemplary embodiments of the present invention,

FIG. 5 shows a signaling diagram of a second example of a data access process according to exemplary embodiments of the present invention,

FIG. 6 shows a schematic diagram illustrating an accessibility of user data using various access keys according to exemplary embodiments of the present invention, and

FIG. 7 shows a schematic diagram of apparatuses according to exemplary embodiments of the present invention.

### DETAILED DESCRIPTION OF DRAWINGS AND EMBODIMENTS OF THE PRESENT INVENTION

The present invention is described herein with reference to particular non-limiting examples and to what are presently considered to be conceivable embodiments of the present invention. A person skilled in the art will appreciate that the invention is by no means limited to these examples, and may be more broadly applied.

It is to be noted that the following description of the present invention and its embodiments mainly refers to specifications being used as non-limiting examples for certain exemplary network configurations and deployments. Namely, the present invention and its embodiments are mainly described in relation to 3GPP specifications being used as non-limiting examples for certain exemplary network configurations and deployments. As such, the description of exemplary embodiments given herein specifically refers to terminology which is directly related thereto. Such terminology is only used in the context of the presented non-limiting examples, and does naturally not limit the invention in any way. Rather, any other network configuration or system deployment, etc. may also be utilized as long as compliant with the features described herein.

In particular, the present invention and its embodiments may be applicable in any fixed or mobile communication system and/or network deployment in which user data is required to be accessed by some ambiguous user identity.

Hereinafter, various embodiments and implementations of the present invention and its aspects or embodiments are described using several variants and/or alternatives. It is generally noted that, according to certain needs and constraints, all of the described variants and/or alternatives may be provided alone or in any conceivable combination (also including combinations of individual features of the various variants and/or alternatives).

According to exemplary embodiments of the present invention, in general terms, there are provided measures and mechanisms for (enabling/realizing) an enhanced data access technique for user data from a home subscriber server.

The enhanced data access technique for user data according to exemplary embodiments of the present invention is applicable and exemplified for a case of user data access between an application server and a home subscriber server in an IP Multimedia Subsystem. In such case, the application server is assumed to desire a user data access using mobile subscriber telephone number (such as e.g. a MSISDN), but is not capable of successfully accomplishing such data access for retrieving user data from the home subscriber server using the mobile subscriber telephone number (such as e.g. the MSISDN) as the mobile subscriber telephone number (such as e.g. the MSISDN) is ambiguous in terms of user (i.e. UE) identification.

Herein, a mobile subscriber ISDN number (MSISDN) is used as an example of a mobile subscriber telephone number for the sake of clarity and by way of example only. Generally, any mobile subscriber telephone number is usable according to exemplary embodiments of the present invention.

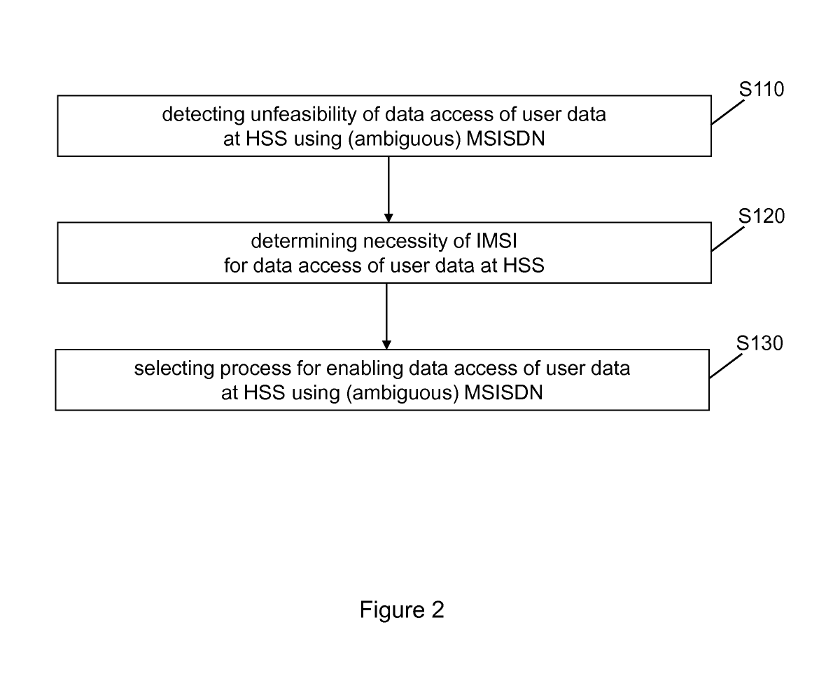

FIG. 2 shows a flowchart of a procedure operable at an application server according to exemplary embodiments of the present invention.

As shown in FIG. 2, a procedure according to exemplary embodiments of the present invention, which is operable e.g. at an AS of an IMS, comprises an operation (S110) of detecting unfeasibility of a data access of (user) data of a specified user (e.g. UE) at a HSS using a mobile subscriber telephone number (such as e.g. a MSISDN) due to ambiguity of the mobile subscriber telephone number (such as e.g. the MSISDN) as a user identity and unavailability of an international mobile subscriber identity (IMSI) as a private identity of the specified user. In such operation, the AS utilizes its knowledge of the shared/ambiguous nature of the MSISDN and the lack of availability of the IMSI (which would be required for resolving such ambiguity for enabling a unique user data access according to conventional specifications) to detect the need for an alternative data access approach according to exemplary embodiments of the present invention. Further, the present procedure comprises an operation (S120) of determining a necessity of the international mobile subscriber identity (IMSI) of the specified user as a private identity for the data access of (user) data of the specified user at the HSS, and an operation (S130) of selecting a process for enabling the data access of (user) data of the specified user at the HSS using the mobile subscriber telephone number (such as e.g. the MSISDN) on the basis of the determined necessity of the international mobile subscriber identity (IMSI).

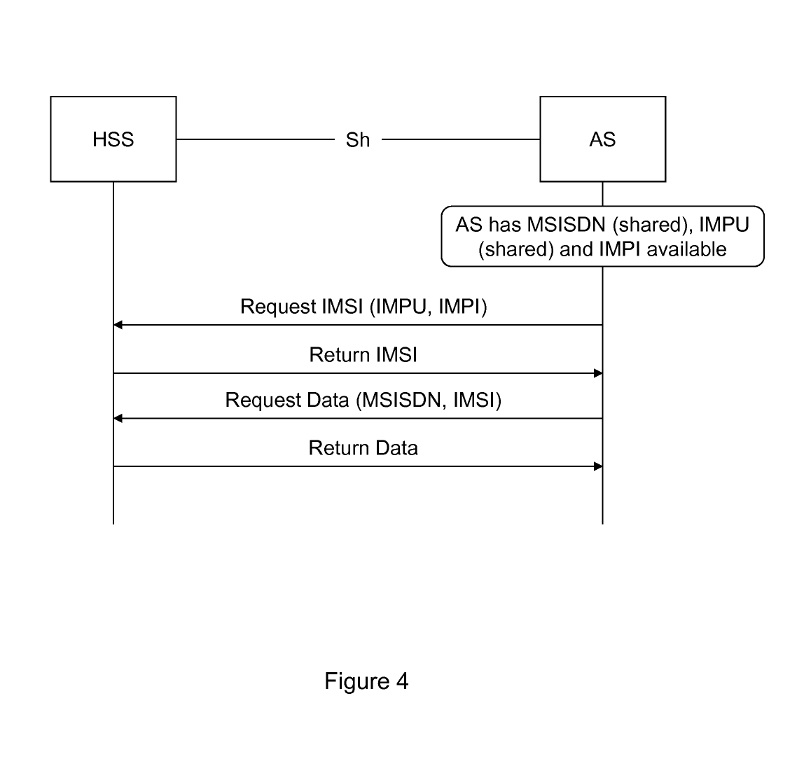

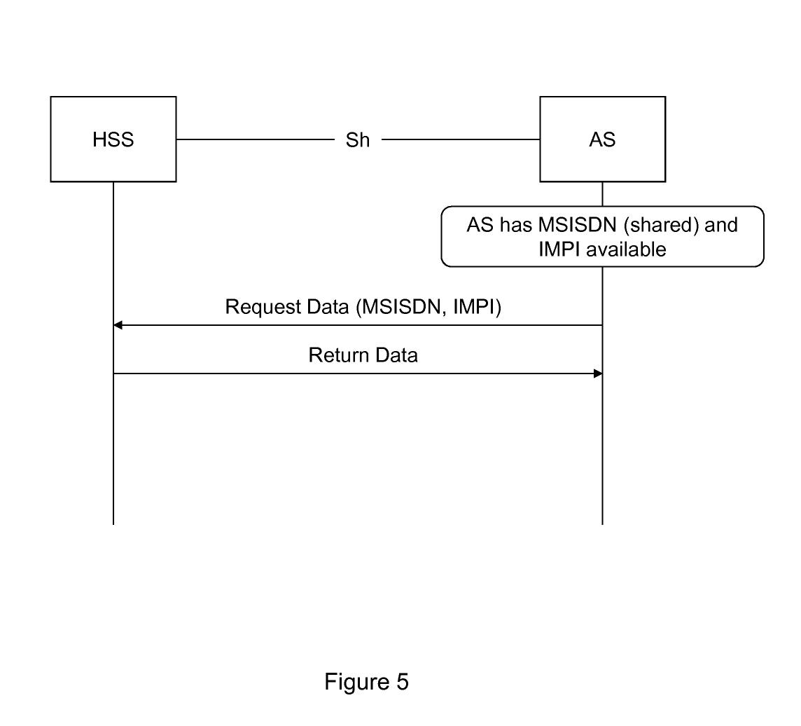

In such operations, the AS decides for that alternative data access approach according to exemplary embodiments of the present invention, which is (more) useful/applicable depending on e.g. the kind of user data to be accessed. Namely, when the IMSI is determined to be necessary (as an access key, e.g. for identification/authorization purposes) for the desired data access at the HSS, the AS could select the exemplary data access process according to FIG. 4, and otherwise the AS select the exemplary data access process according to FIG. 5.

Generally, user data being accessible according to exemplary embodiments of the present invention could be any kind of user-related data which is stored at the HSS (in the context of an IMS subscription). This includes data which is not part of the IMS subscription as such, such as data that the HSS could fetch from e.g. a HLR. Such data could for example comprise location data of a subject user, or the like.

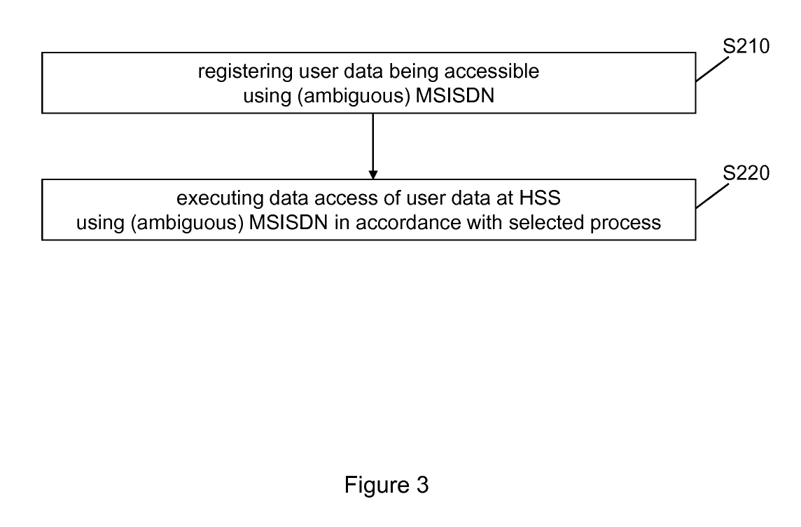

FIG. 3 shows a flowchart of a procedure operable at a home subscriber server according to exemplary embodiments of the present invention.

As shown in FIG. 3, a procedure according to exemplary embodiments of the present invention, which is operable e.g. at a HSS of an IMS, comprises an operation (S210) of registering (user) data of a specified user, which is accessible using a mobile subscriber telephone number (such as e.g. a MSISDN) being (potentially) ambiguous as a user identity. That is to say, the HSS offers data access to user data using the MSISDN as access key, i.e. is operable according to the second use case mentioned above. Further, the present procedure comprises an operation (S220) of executing data access using the mobile subscriber telephone number (such as e.g. the MSISDN) in accordance with a selected process for enabling the data access of (user) data of the specified user using the mobile subscriber telephone number (such as e.g. the MSISDN) depending on a necessity of an international mobile subscriber identity (IMSI) of the specified user for the data access of (user) data of the specified user at an AS. That is to say, the HSS is capable of adaptively operating in accordance with an alternative data access approach according to exemplary embodiments of the present invention, which is selected by the AS (see operation S130 of FIG. 3). Namely, upon corresponding requests from the AS, the HSS could adjust to any one of the exemplary data access processes according to FIG. 4 and FIG. 5.

FIG. 4 shows a signaling diagram of a first example of a data access process according to exemplary embodiments of the present invention.

As shown in FIG. 4, when the AS has available a shared MSISDN, a shared IMPU and an IMPI of a user whose user data are desired to be accessed at the HSS using the MSISDN-based data access approach, a data access process may be as follows. As mentioned above, such data access approach may be selected when the IMSI is determined to be necessary, i.e. when the IMSI is necessary (as an access key) for accessing the desired user data at the HSS.

Firstly, the AS retrieves the IMSI of the subject user from the HSS using the (shared) IMPU and the IMPI of the subject user. Such retrieval could be accomplished by requesting the IMSI from the HSS with the (shared) IMPU and the IMPI of the subject user being used as access keys. Upon such request, the HSS accesses the user data of the subject user, reads its IMSI, and returns the IMSI to the requesting AS.

While the illustrated exemplary process is based on the assumption that the IMPU available at the AS is shared, a corresponding process is also applicable for the case that the IMPU available at the AS is not shared but unique. In such case, the (unique) IMPU of the subject user is used as the only access key for requesting the IMSI from the HSS.

For retrieving the IMSI of the subject user, as outlined above, the AS may map the MSISDN intended to be used as an access key for data access to the IMPU (and the IMPI) to be used for the IMSI retrieval. Such mapping may be achieved on the basis of user identification (association) data being available locally and/or remotely.

Secondly, the AS retrieves the desired (user) data of the subject user from the HSS using the MSISDN and the previously retrieved IMSI of the subject user. Such retrieval could be accomplished by requesting the user data from the HSS with the (shared) MSISDN and the IMSI of the subject user being used as access keys. In particular, the (shared) MSISDN could be used as user identity, and the IMSI of the subject user could be used as private identity. Upon such request, the HSS accesses the user data, reads the requested data, and returns the requested data to the requesting AS. In the present example, the requested and returned data may be transparent data (such as data being stored by the AS in the HSS using it as a repository) and/or non-transparent data (such as user profile related data).

As described above, when the AS needs to access user data and is aware that an MSISDN (which is available at the AS) is shared, but the IMSI is not available, it will retrieve the IMSI from the HSS via the Sh interface using the IMPU as access key. Where the IMPU is not unique, the AS uses the IMPI as an additional access key to uniquely identify the user data. Once the IMSI is available at the AS, the AS can use the IMSI in combination with the MSISDN to uniquely identify the user so as to access the user data. As the AS can derive the IMPU (and, if required, the IMPI) of the subject user, it is possible for the AS to uniquely retrieve the IMSI of the subject user.

FIG. 5 shows a signaling diagram of a second example of a data access process according to exemplary embodiments of the present invention.

As shown in FIG. 5, when the AS has available a shared MSISDN and an IMPI of a user whose data are desired to be accessed at the HSS using the MSISDN-based data access approach, a data access process may be as follows. As mentioned above, such data access approach may be selected when the IMSI is determined to be not necessary, i.e. when the IMSI is not necessary (as an access key) for accessing the desired user data at the HSS.

Then, the AS retrieves the desired data of the subject user from the HSS using the MSISDN and the IMPI of the subject user. Such retrieval could be accomplished by requesting the user data from the HSS with the (shared) MSISDN and the IMPI of the subject user being used as access keys. In particular, the (shared) MSISDN could be used as user identity, and the IMPI of the subject user could be used as private identity. Upon such request, the HSS accesses the (user) data of the subject user, reads the requested data, and returns the requested data to the requesting AS. In the present example, the requested and returned data may be transparent data (such as data being stored by the AS in the HSS using it as a repository) and/or non-transparent data (such as user profile related data).

For retrieving the IMSI of the subject user, as outlined above, the AS may map the MSISDN initially intended to be used as an access key for data access to the IMPI to be additionally used as an access key for data access. Such mapping may be achieved on the basis of user identification (association) data being available locally and/or remotely.

As described above, when the AS needs to access user data or a user profile and is aware that an MSISDN (which is available at the AS) is shared, but the IMSI is not available, it will retrieve the user data or the user profile from the HSS via the Sh interface using, in addition to the MSISDN, the IMPI (rather than the IMSI according to conventional specifications) as additional access key to uniquely identify the user so as to access the user data or the user profile. As the HSS can uniquely identify the subject user (i.e. the requested data) using the combination of MSISDN and IMPI, there is no need for the AS to know or retrieve the IMSI of the subject user.

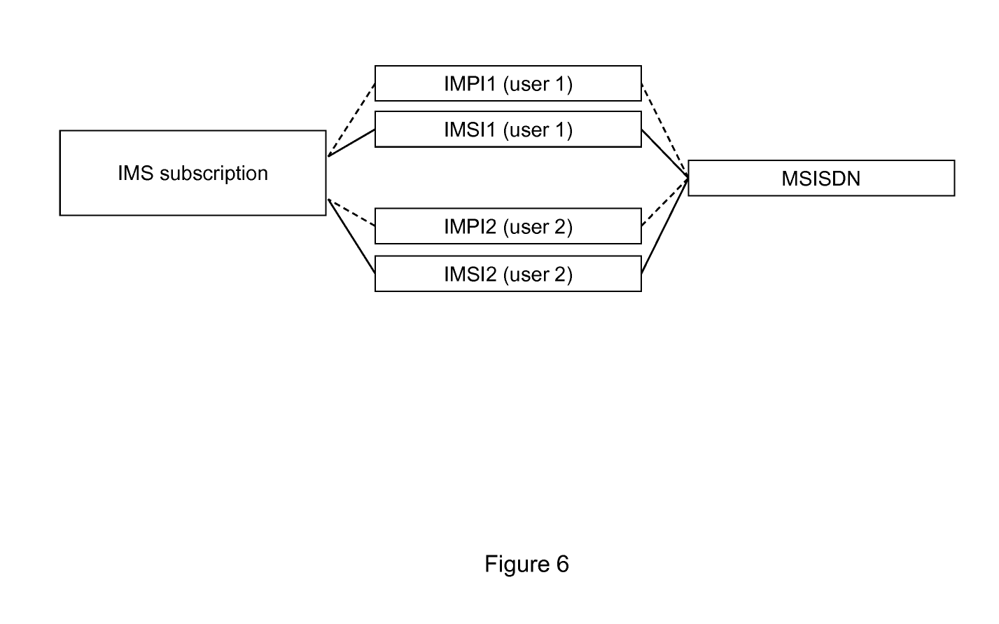

FIG. 6 shows a schematic diagram illustrating an accessibility of user data using various access keys according to exemplary embodiments of the present invention. In FIG. 6, the IMPU-based data access approach is omitted for the sake of clarity only, but is still applicable according to exemplary embodiments of the present invention.

As evident from FIG. 6, it is assumed that the HSS comprises an IMS subscription including user data e.g. for user 1 and user 2, respectively. Further, it is assumed that MSISDN represents an ambiguous user identity which is shared between users 1 and 2. On the one hand, as depicted by solid lines, the user data for user 1/2 can be accessed by using MSISDN and IMSI1/IMSI2 as access keys. To this end, the IMSI1/IMSI2 is to be available at the requesting AS or, otherwise, has to be retrieved by way of the exemplary data access process according to FIG. 4. On the other hand, as depicted by broken lines, the user data for user 1/2 can be accessed by using MSISDN and IMPI1/IMPI2 as access keys. To this end, the IMPI1/IMPI2 is to be available at the requesting AS, and the exemplary data access process according to FIG. 5 is applicable.

According to exemplary embodiments of the present invention, the above procedures and processes are applicable in an IMS between (any kind of) AS and (any kind of HSS). For example, the AS may comprise or be operable as a SIP AS, an IM SSF, and/or an OSA SCS. Also, the AS may for example comprise or be operable as a (mobile) VoIP server, or a (mobile) VoIP server may acts as the AS in the IMS. Further, the AS may be interfaced with the HSS either directly or via a SLF. Still further, the above procedures and processes may relate to or be involved in an IP multimedia session or call.

As a non-limiting example, the enhanced data access technique for user data according to exemplary embodiments of the present invention may be adopted in an IMS implementation that provides ISC gateway functionality.

According to exemplary embodiments of the present invention, the above procedures and processes are operable in accordance with the specifications of 3GPP TS 29.328. In such case, retrieval of the user data comprises issuing a pull request message indicating requested user data from the AS to the HSS and obtaining a pull response message including the requested user data at the AS from the HSS. That is to say, the message for requesting data from the HSS may be a Data Read (or Sh-Pull) message, and the message for returning data to the AS may be a Data Read (or Sh-Pull-Resp) message.

According to exemplary embodiments of the present invention, the above procedures and processes are operable in accordance with the specifications of 3GPP TS 29.329. In such case, the Sh interface is implemented on the basis of the Diameter protocol, the AS acts as a Diameter client, and the HSS acts as a Diameter server. Further, retrieval of the user data comprises issuing a user data request message indicating requested user data from the AS to the HSS and obtaining a user data answer message including the requested user data at the AS from the HSS. That is to say, the message for requesting data from the HSS may be a User-Data-Request (UDR) message, and the message for returning data to the AS may be a User-Data-Answer (UDA) message.

By virtue of exemplary embodiments of the present invention, a data access technique for user data from a home subscriber system is enhanced. Accordingly, when applying the thus enhanced data access technique for user data between an application server and a home subscriber server in an IP Multimedia Subsystem, the (functionality of the) Sh interface is enhanced.

In view of the above, the enhanced data access technique for user data according to exemplary embodiments of the present invention is effective and thus beneficial in addressing the above-outlined problem of an unfeasibility of user data access due to an ambiguity of an access key parameter as user identity, i.e. in terms of user identification. Accordingly, when applying the thus enhanced data access technique for user data between an application server and a home subscriber server in an IP Multimedia Subsystem, such problem is addressed in that the application server desiring a user data access using a mobile subscriber telephone number (such as e.g. a MSISDN), is enabled for such user data access, even if the mobile subscriber telephone number (such as e.g. the MSISDN) is ambiguous and an associated private identity such as an international mobile subscriber identity (i.e. IMSI) is not available at the application server.

The above-described procedures and functions may be implemented by respective functional elements, processors, or the like, as described below.

While in the foregoing exemplary embodiments of the present invention are described mainly with reference to methods, procedures and functions, corresponding exemplary embodiments of the present invention also cover respective apparatuses, network nodes and systems, including both software and/or hardware thereof.

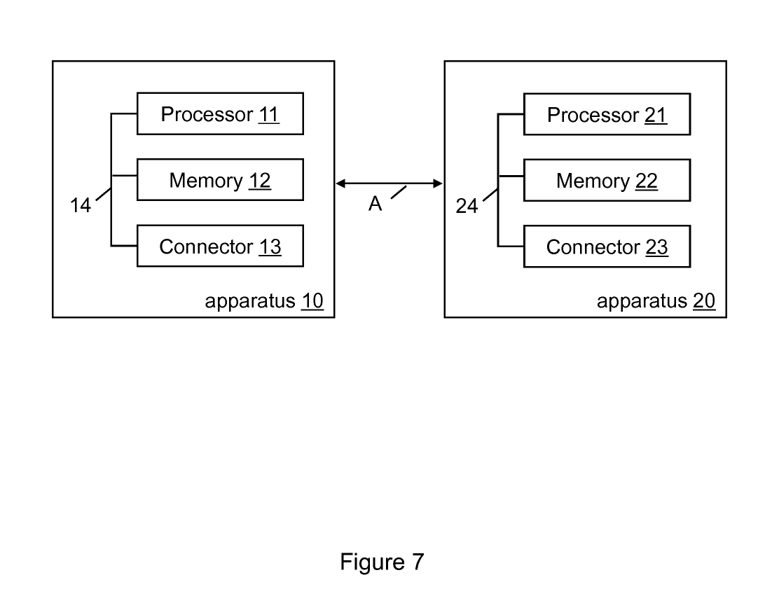

Respective exemplary embodiments of the present invention are described below referring to FIG. 7, while for the sake of brevity reference is made to the detailed description of respective corresponding configurations/setups, schemes, methods and functionality, principles and operations according to FIGS. 2 to 6.

In FIG. 7 below, the solid line blocks are basically configured to perform respective operations as described above. The entirety of solid line blocks are basically configured to perform the methods and operations as described above, respectively. With respect to FIG. 7, it is to be noted that the individual blocks are meant to illustrate respective functional blocks implementing a respective function, process or procedure, respectively. Such functional blocks are implementation-independent, i.e. may be implemented by means of any kind of hardware or software, respectively. The arrows and lines interconnecting individual blocks are meant to illustrate an operational coupling there-between, which may be a physical and/or logical coupling, which on the one hand is implementation-independent (e.g. wired or wireless) and on the other hand may also comprise an arbitrary number of intermediary functional entities not shown. The direction of arrow is meant to illustrate the direction in which certain operations are performed and/or the direction in which certain data is transferred.

Further, in FIG. 7, only those functional blocks are illustrated, which relate to any one of the above-described methods, procedures and functions. A skilled person will acknowledge the presence of any other conventional functional blocks required for an operation of respective structural arrangements, such as e.g. a power supply, a central processing unit, respective memories or the like. Among others, memories are provided for storing programs or program instructions for controlling the individual functional entities to operate as described herein.

FIG. 7 shows a schematic diagram of apparatuses according to exemplary embodiments of the present invention.

In view of the above, the thus illustrated apparatuses 10 and 20 are suitable for use in practicing the exemplary embodiments of the present invention, as described herein.

The thus illustrated apparatus 10 corresponds to an entity which may represent a (part of a) server device such as a AS or a corresponding modem (which may be installed as part thereof, but may be also a separate module, which can be attached to various devices), and may be configured to perform a procedure and/or provide a functionality as described in conjunction with any one of FIGS. 2 and 4 to 6. The thus illustrated apparatus 20 corresponds to an entity which may represent a (part of a) server device such as a HSS or a corresponding modem (which may be installed as part thereof, but may be also a separate module, which can be attached to various devices), and may be configured to perform a procedure and/or provide a functionality as described in conjunction with any one of FIGS. 2, 3, 5, and 6.

As indicated in FIG. 7, according to exemplary embodiments of the present invention, each of the apparatuses 10/20 comprises a processor 11/21, a memory 12/22 and a connector 13/23, which are connected by a bus 14/24 or the like. The apparatuses 10 and 20 may be connected via link A representing at least one connection such as a Sh interface connection.

The processor 11/21 and/or the interface 13/23 may also include a modem or the like to facilitate communication over a (hardwire or wireless) link, respectively. The connector 13/23 may include a suitable transceiver coupled to one or more antennas or communication means for (hardwire or wireless) communications with the linked or connected device(s), respectively. The connector 13/23 is generally configured to communicate with at least one other apparatus, i.e. the connector thereof.

The memory 12/22 may store respective programs assumed to include program instructions or computer program code that, when executed by the respective processor, enables the respective electronic device or apparatus to operate in accordance with the exemplary embodiments of the present invention. For example, the memory 21 may store user identification (association) data or the like, the memory 22 may store user data (e.g. non-/transparent data, user profiles, etc.) or the like.

In general terms, the respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

When in the subsequent description it is stated that the processor (or some other means) is configured to perform some function, this is to be construed to be equivalent to a description stating that a (i.e. at least one) processor or corresponding circuitry, potentially in cooperation with computer program code stored in the memory of the respective apparatus, is configured to cause the apparatus to perform at least the thus mentioned function. Also, such function is to be construed to be equivalently implementable by specifically configured circuitry or means for performing the respective function (i.e. the expression “processor configured to [cause the apparatus to] perform xxx-ing” is construed to be equivalent to an expression such as “means for xxx-ing”).

In its most basic form, according to exemplary embodiments of the present invention, the apparatus 10 or its processor 11 is configured to perform detecting unfeasibility of a data access of (user) data of a specified user at a home subscriber server using a mobile subscriber telephone number (such as e.g. a MSISDN) due to ambiguity of the mobile subscriber telephone number (such as e.g. the MSISDN) as a user identity and unavailability of an international mobile subscriber identity as a private identity of the specified user, determining a necessity of the international mobile subscriber identity of the specified user as a private identity for the data access of (user) data of the specified user at the home subscriber server, and selecting a process for enabling the data access of (user) data of the specified user at the home subscriber server using the mobile subscriber telephone number (such as e.g. the MSISDN) on the basis of the determined necessity of the international mobile subscriber identity.

Accordingly, stated in other words, the apparatus 10 at least comprises respective means for detecting unfeasibility of a data access of (user) data of a specified user at a home subscriber server using a mobile subscriber telephone number, means for determining a necessity of the international mobile subscriber identity of the specified user as a private identity for the data access of (user) data of the specified user, and means for selecting a process for enabling the data access of (user) data of the specified user at the home subscriber server using the mobile subscriber telephone number.

In its most basic form, according to exemplary embodiments of the present invention, the apparatus 20 or its processor 21 is configured to perform registering (user) data of a specified user, which is accessible using a mobile subscriber telephone number (such as e.g. a MSISDN) being ambiguous as a user identity, and executing data access using the mobile subscriber telephone number (such as e.g. the MSISDN) in accordance with a selected process for enabling the data access of (user) data of the specified user using the mobile subscriber telephone number (such sa e.g. the MSISDN) depending on a necessity of an international mobile subscriber identity of the specified user for the data access of (user) data of the specified user at the application server.

Accordingly, stated in other words, the apparatus 20 at least comprises respective means for registering (user) data of a specified user and means for executing data access using the mobile subscriber telephone number in accordance with a selected process for enabling the data access of (user) data of the specified user using the mobile subscriber telephone number.

For further details regarding the operability/functionality of the individual apparatuses, reference is made to the above description in connection with any one of FIGS. 2 to 6, respectively.

According to exemplarily embodiments of the present invention, the processor 11/21, the memory 12/22 and the connector 13/23 may be implemented as individual modules, chips, chipsets, circuitries or the like, or one or more of them can be implemented as a common module, chip, chipset, circuitry or the like, respectively.

According to exemplarily embodiments of the present invention, a system may comprise any conceivable combination of the thus depicted devices/apparatuses and other network elements, which are configured to cooperate as described above.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present invention. Such software may be software code independent and can be specified using any known or future developed programming language, such as e.g. Java, C++, C, and Assembler, as long as the functionality defined by the method steps is preserved. Such hardware may be hardware type independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components. A device/apparatus may be represented by a semiconductor chip, a chipset, or a (hardware) module comprising such chip or chipset; this, however, does not exclude the possibility that a functionality of a device/apparatus or module, instead of being hardware implemented, be implemented as software in a (software) module such as a computer program or a computer program product comprising executable software code portions for execution/being run on a processor. A device may be regarded as a device/apparatus or as an assembly of more than one device/apparatus, whether functionally in cooperation with each other or functionally independently of each other but in a same device housing, for example.

Apparatuses and/or means or parts thereof can be implemented as individual devices, but this does not exclude that they may be implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present invention also covers any conceivable combination of method steps and operations described above, and any conceivable combination of nodes, apparatuses, modules or elements described above, as long as the above-described concepts of methodology and structural arrangement are applicable.

In summary, there are provided measures for an enhanced data access technique for user data from a home subscriber system. Such measures exemplarily comprise detection of unfeasibility of a data access of data of a specified user at a home subscriber server using a mobile subscriber telephone number due to ambiguity of the mobile subscriber telephone number as a user identity and unavailability of an international mobile subscriber identity as a private identity of the specified user, and selection of a process for enabling the data access of data of the specified user at the home subscriber server using the mobile subscriber telephone number on the basis of a necessity of the international mobile subscriber identity as a private identity for the data access of data of the specified user.

Even though the invention is described above with reference to the examples according to the accompanying drawings, it is to be understood that the invention is not restricted thereto. Rather, it is apparent to those skilled in the art that the present invention can be modified in many ways without departing from the scope of the inventive idea as disclosed herein.

### LIST OF ACRONYMS AND ABBREVIATIONS

3GPP 3rd Generation Partnership Project
AS Application Server
CSCF Call Session Control Function
HLR Home Location Register
HSS Home Subscriber Server
I-CSCF Interrogating CSCF
IP Internet Protocol
IMPI IP Multimedia Private Identity
IMPU IP Multimedia Public Identity
IMS Internet Multimedia Subsystem
IMSI International Mobile Subscriber Identity
ISC IMS Service Control
ISDN Integrated Services Digital Network
LTE Long Term Evolution
LTE-A LTE-Advanced
MSISDN Mobile Subscriber ISDN Number
OSA Open Service Access
S-CSCF Serving CSCF
SIP Session Initiation Protocol
SCS Service Capability Server
SLF Subscription Locator Function
IM SSF IP Multimedia Switching Function
UE User Equipment

1. A method comprising
detecting unfeasibility of a data access of data of a specified user at a home subscriber server using a mobile subscriber telephone number due to ambiguity of the mobile subscriber telephone number as a user identity and unavailability of an international mobile subscriber identity as a private identity of the specified user,
determining a necessity of the international mobile subscriber identity of the specified user as a private identity for the data access of data of the specified user at the home subscriber server, and
selecting a process for enabling the data access of data of the specified user at the home subscriber server using the mobile subscriber telephone number on the basis of the determined necessity of the international mobile subscriber identity.

2. The method according to claim 1, wherein, when the international mobile subscriber identity of the specified user is determined to be necessary, the selected process comprises:
retrieving the international mobile subscriber identity of the specified user from the home subscriber server using an IP multimedia public identity of the specified user or using an IP multimedia public identity and an IP multimedia private identity of the specified user, and
retrieving the data of the specified user by enabling the data access of data of the specified user at the home subscriber server using the mobile subscriber telephone number as the user identity and the retrieved international mobile subscriber identity of the specified user as the private identity.

3. The method according to claim 1, wherein, when the international mobile subscriber identity of the specified user is determined to be not necessary, the selected process comprises:
retrieving the data of the specified user by enabling the data access of data of the specified user at the home subscriber server using the mobile subscriber telephone number as the user identity and an IP multimedia private identity of the specified user as the private identity.

4. The method according to claim 2, wherein retrieving the data comprises one of:
issuing a pull request message indicating requested data to the home subscriber server, and obtaining a pull response message including the requested data from the home subscriber server, and
issuing a user data request message indicating requested data to the home subscriber server on the basis of a Diameter protocol, and obtaining a user data answer message including the requested data from the home subscriber server on the basis of the Diameter protocol.

5. The method according to claim 1, wherein
the method is operable at or by an application server, and/or
the method is operable in an IP multimedia subsystem.

6. A method comprising
registering data of a specified user, which is accessible using a mobile subscriber telephone number being ambiguous as a user identity, and
executing data access using the mobile subscriber telephone number in accordance with a selected process for enabling the data access of data of the specified user using the mobile subscriber telephone number depending on a necessity of an international mobile subscriber identity of the specified user for the data access of data of the specified user at the application server.

7. The method according to claim 6, wherein executing the data access comprises
accessing, upon a request comprising an IP multimedia public identity of the specified user or an IP multimedia public identity and an IP multimedia private identity of the specified user, the international mobile subscriber identity of the specified user using the IP multimedia public identity of the specified user or using the IP multimedia public identity and the IP multimedia private identity of the specified user, and returning the international mobile subscriber identity of the specified user to the application server, and
accessing, upon a request comprising the mobile subscriber telephone number and the international mobile subscriber identity of the specified user, the data of the specified user using the mobile subscriber telephone number as the user identity and the international mobile subscriber identity of the specified user as a private identity.

8. The method according to claim 6, wherein executing the data access comprises
accessing, upon a request comprising the mobile subscriber telephone number and an IP multimedia private identity of the specified user, the data of the specified user using the mobile subscriber telephone number as the user identity and the IP multimedia private identity of the specified user as a private identity.

9. The method according to claim 7, wherein accessing and returning the data comprises one of:
obtaining a pull request message indicating requested data from the application server, and issuing a pull response message including the requested data to the application server, and
obtaining a user data request message indicating requested data from the application server on the basis of a Diameter protocol, and issuing a user data answer message including the requested data to the application server on the basis of the Diameter protocol.

10. The method according to claim 6, wherein
the method is operable at or by a home subscriber server, and/or
the method is operable in an IP multimedia subsystem.

11. An apparatus comprising
a connector configured to connect to at least another apparatus,
a memory configured to store computer program code, and
a processor configured to cause the apparatus to perform:
detecting unfeasibility of a data access of data of a specified user at a home subscriber server using a mobile subscriber telephone number due to ambiguity of the mobile subscriber telephone number as a user identity and unavailability of an international mobile subscriber identity as a private identity of the specified user,
determining a necessity of the international mobile subscriber identity of the specified user as a private identity for the data access of data of the specified user at the home subscriber server, and
selecting a process for enabling the data access of data of the specified user at the home subscriber server using the mobile subscriber telephone number on the basis of the determined necessity of the international mobile subscriber identity.

12. The apparatus according to claim 11, wherein, when the international mobile subscriber identity of the specified user is determined to be necessary, the processor is configured to cause the apparatus to perform:
retrieving the international mobile subscriber identity of the specified user from the home subscriber server using an IP multimedia public identity of the specified user or using an IP multimedia public identity and an IP multimedia private identity of the specified user, and
retrieving the data of the specified user by enabling the data access of data of the specified user at the home subscriber server using the mobile subscriber telephone number as the user identity and the retrieved international mobile subscriber identity of the specified user as the private identity.

13. The apparatus according to claim 11, wherein, when the international mobile subscriber identity of the specified user is determined to be not necessary, the processor is configured to cause the apparatus to perform:
retrieving the data of the specified user by enabling the data access of data of the specified user at the home subscriber server using the mobile subscriber telephone number as the user identity and an IP multimedia private identity of the specified user as the private identity.

14. The apparatus according to claim 12, wherein the processor is configured to cause the apparatus to perform retrieving the data by performing one of:
issuing a pull request message indicating requested data to the home subscriber server, and obtaining a pull response message including the requested data from the home subscriber server, and
issuing a user data request message indicating requested data to the home subscriber server on the basis of a Diameter protocol, and obtaining a user data answer message including the requested data from the home subscriber server on the basis of the Diameter protocol.

15. The apparatus according to claim 11, wherein
the apparatus is operable as or at an application server, and/or
the apparatus is operable in an IP multimedia subsystem.

16. An apparatus comprising
a connector configured to connect to at least another apparatus,
a memory configured to store computer program code, and
a processor configured to cause the apparatus to perform:
registering data of a specified user, which is accessible using a mobile subscriber telephone number being ambiguous as a user identity, and
executing data access using the mobile subscriber telephone number in accordance with a selected process for enabling the data access of data of the specified user using the mobile subscriber telephone number depending on a necessity of an international mobile subscriber identity of the specified user for the data access of data of the specified user at the application server.

17. The apparatus according to claim 16, wherein the processor is configured to cause the apparatus to perform executing the data access by performing:
accessing, upon a request comprising an IP multimedia public identity of the specified user or an IP multimedia public identity and an IP multimedia private identity of the specified user, the international mobile subscriber identity of the specified user using the IP multimedia public identity of the specified user or using the IP multimedia public identity and the IP multimedia private identity of the specified user, and returning the international mobile subscriber identity of the specified user to the application server, and
accessing, upon a request comprising the mobile subscriber telephone number and the international mobile subscriber identity of the specified user, the data of the specified user using the mobile subscriber telephone number as the user identity and the international mobile subscriber identity of the specified user as a private identity.

18. The apparatus according to claim 16, wherein the processor is configured to cause the apparatus to perform executing the data access by performing:
accessing, upon a request comprising the mobile subscriber telephone number and an IP multimedia private identity of the specified user, the data of the specified user using the mobile subscriber telephone number as the user identity and the IP multimedia private identity of the specified user as a private identity.

19. The apparatus according to claim 17, wherein the processor is configured to cause the apparatus to perform accessing and returning the data by performing one of:
obtaining a pull request message indicating requested data from the application server, and issuing a pull response message including the requested data to the application server, and
obtaining a user data request message indicating requested data from the application server on the basis of a Diameter protocol, and issuing a user data answer message including the requested data to the application server on the basis of the Diameter protocol.

20. The apparatus according to claim 16, wherein
the apparatus is operable as or at a home subscriber server, and/or
the apparatus is operable in an IP multimedia subsystem.

21. A computer program product embodied on a non-transitory computer-readable medium, said product comprising computer-executable computer program code which, when the program is run on a computer, is configured to cause the computer to carry out the method according to claim 1.

22. (canceled)
